(19) United States
(12) Patent Application Publication
(10) Pub. No.: US 2026/0170601 A1
(43) Pub. Date: Jun. 18, 2026

(54) IMAGE PROCESSING APPARATUS, IMAGE PROCESSING METHOD, AND COMPUTER-READABLE STORAGE MEDIUM

(71) Applicant: CANON KABUSHIKI KAISHA, Tokyo (JP)

(72) Inventor: MASAAKI KOBAYASHI, Tokyo (JP)

(21) Appl. No.: 19/413,149

(22) Filed: Dec. 9, 2025

(30) Foreign Application Priority Data
Dec. 18, 2024 (JP) 2024-221925

(51) Int. Cl. G06T 3/08; G06T 3/047; G06T 5/70; G06T 5/80; H04N 23/69

(52) U.S. Cl. CPC G06T 3/08; G06T 3/047; G06T 5/70; G06T 5/80; H04N 23/69

(57) ABSTRACT

An image processing apparatus obtains an image with a wide angle of view in which an angle of view exceeds a predetermined value, restricts an image region in the image with a wide angle of view that is used for projection conversion to a restricted image region; and performs projection conversion of a coordinate system of an image in the restricted image region in the image with a wide angle of view into a coordinate system of an image of an output target.

### BACKGROUND

### Field of the Technology

The present disclosure relates to image conversion in a case of obtaining an image with a wide angle of view.

### Description of the Related Art

Conventionally, a wide-angle lens and a fisheye lens have been known as a lens that can capture a subject with a wide angle of view, for example. Particularly, since the fisheye lens has an angle of view of 180° or greater, an image with a wide angle of view is obtained by a single lens. Additionally, in recent years, along with a development of a technique of a head-mounted display (HMD), it has been able to input an image with an ultra-high angle of view, which is an angle of view greater than 180°, to the HMD, and the HMD can display an image cut out at the angle of view displayed in a front direction of the HMD in real time. As the image with an ultra-high angle of view inputted to the HMD, an image obtained by converting an image captured by the fisheye lens into an equidistant cylindrical image of 180° is usually used. However, since the fisheye lens has a wide angle of view, a missing region where a part of the image is missing tends to occur. To deal with this, Japanese Patent Laid-Open No. 2022-184139 discloses a technique of filling up a missing region in a case where there are right and left circumferential fisheye images, and one of the circumferential fisheye images includes the missing region, by copying a part of an image of a region corresponding to the other circumferential fisheye image.

### SUMMARY

An image processing apparatus according to an aspect of the present disclosure includes: an image obtainment unit configured to obtain an image with a wide angle of view, the wide angle of view being an angle of view exceeding a predetermined value; a restriction unit configured to restrict an image region to a restricted image region, the image region used for projection conversion in the image with the wide angle of view; and a conversion unit configured to perform projection conversion of a coordinate system of an image in the restricted image region into a coordinate system of an image of an output target, in the image with the wide angle of view.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram describing a system configuration of an image processing apparatus;

FIG. 2A is a diagram describing processing of projection conversion into an equidistant cylindrical image in a first embodiment;

FIG. 2B is a diagram describing processing of the projection conversion into the equidistant cylindrical image in a second embodiment;

FIG. 2C is a diagram describing processing of the projection conversion into the equidistant cylindrical image in a third embodiment;

FIG. 3 is a flowchart describing the projection conversion from a fisheye image into an equidistant cylindrical image with an angle of view of 180° according to the first embodiment;

FIG. 4 is a flowchart describing the projection conversion from the fisheye image into the equidistant cylindrical image with an angle of view of 180° according to the second embodiment;

FIG. 5 is a flowchart describing the projection conversion from the fisheye image into the equidistant cylindrical image with an angle of view of 180° according to the third embodiment;

FIG. 6 is a flowchart describing the projection conversion from the fisheye image into the equidistant cylindrical image with an angle of view of 180° according to a fourth embodiment;

FIG. 7 is a flowchart describing the projection conversion from the fisheye image into the equidistant cylindrical image with an angle of view of 180° according to a fifth embodiment;

FIG. 8A is a diagram illustrating an example of the fisheye image captured by using a fisheye lens;

FIG. 8B is a diagram illustrating an example of the equidistant cylindrical image obtained by projection-converting the fisheye image in FIG. 8A;

FIG. 8C is a diagram illustrating an example of the equidistant cylindrical image that is obtained by restricting an image region as a target of the projection conversion by a condition set in advance, compared to the equidistant cylindrical image in FIG. 8B;

FIG. 8D is a diagram illustrating an example of the equidistant cylindrical image that is obtained by restricting the image region as the target of the projection conversion by another condition, compared to the equidistant cylindrical image in FIG. 8C;

FIG. 9A is a diagram illustrating a slider corresponding to each of a threshold of an effective image height, a shading-starting moving radius, and a shading-ending moving radius; and

FIG. 9B is a diagram illustrating a slider corresponding to each of a chroma-reduction-starting moving radius and a chroma-reduction-ending moving radius in addition to the threshold of the effective image height, the shading-starting moving radius, and the shading-ending moving radius.

### DESCRIPTION OF THE EMBODIMENTS

In the following, preferable embodiments of the present invention are described in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same constituents are denoted by the same reference numerals.

### Overview

In recent years, along with a development of a technology of a head-mounted display (HMD), it has been able to input an image with an ultra-high angle of view, which is an angle of view greater than 180°, to the HMD, and the HMD can display an image cut out at the angle of view displayed in a front direction of the HMD in real time. According to the real-time display as described above, the user can view a so-called virtual reality (VR) image easily via the HMD. Additionally, as the image with an ultra-high angle of view inputted to the HMD, an image obtained by projection-converting an image captured by a fisheye lens into an equidistant cylindrical image of 180° is usually used. Alternatively, as the image of an ultra-high angle of view inputted to the HMD, an equidistant cylindrical image of 360° generated by synthesizing two images captured by two fisheye lenses disposed in directions 180° different from each other may be used. Alternatively, as the image with an ultra-high angle of view inputted to the HMD, a stereo image generated by capturing with two fisheye lenses disposed side by side in the same direction may be used.

In general, the angle of view that the HMD can display at one time is 90° to 120°. The user can also view an image with a wider angle of view by shaking their own neck horizontally. Additionally, since the fisheye lens has a wide angle of view, vignetting tends to occur. The vignetting is a black portion that occurs at a corner of a screen. The black portion occurs because a lens hood or a filter shows up in black in the image. In other words, because of the wide angle of view, a part of a lens or a camera casing shows up in the image, and a vignetting region where a part of the image is missing (also referred to as a missing region) may occur. It is also possible to remove the missing region by coloring the above-described missing region with a predetermined color such as black.

Additionally, the fisheye lens includes a circular fisheye lens and a diagonal fisheye lens. The circular fisheye lens is a lens that cuts out the image in a circular shape. An image captured by using the circular fisheye lens has a strong distortion at four corners of the image and is a spherical image that is distorted entirely. The diagonal fisheye lens is a lens that has the maximum viewing angle on the diagonal. An image captured by using the diagonal fisheye lens is distorted spherically from the center to the periphery of the image. Additionally, a projection type of the fisheye lens includes an equisolid projection type and an equidistance projection type, for example. The equisolid projection type is a type appropriate for capturing an expanse of nature such as a panoramic photograph and a landscape photograph. The equidistance projection type is a type appropriate for a case that requires precise angle measurement such as astronomy and a dome theater. The projection type of the fisheye lens also includes an orthogonal projection type and a stereographic projection type. The orthogonal projection type is a type that removes perspective and is appropriate for displaying at an equal scale without distortion of the shape and dimension of an object. The orthogonal projection type is a type that is balanced in angle and area and is appropriate for a panoramic photograph and video production. Note that, the angle of view of the fisheye lens is about 180° or greater while the angle of view of the wide-angle lens is about 60° or greater.

At a corner of the image captured by using an image capturing optical system that can obtain the image with a wide angle of view exceeding a predetermined value as described above, false color may occur, and the image may be deteriorated. In a case where the false color as described above occurs, the immersiveness of the user may be diminished. Additionally, the missing region may occur at the corner of the image. Even in a case where the missing region as described above is painted a predetermined color such as black, the user viewing the image finds a black region at the end of a field of view of the user. Particularly, in a case where the equidistant cylindrical image with which an image height of the fisheye lens has a wider angle of view than an effective image height is generated, and an image region outside the effective image height is painted black in the equidistant cylindrical image, the following may occur. That is, in a case where the user changes a viewing direction while viewing the HMD, the black region suddenly appears at the end of the field of view of the user. The black region may diminish the immersiveness of the user.

Therefore, in the present disclosure, the image region in the image with a wide angle of view that is used for the projection conversion is restricted to a restricted image region. Additionally, in the image with a wide angle of view, a coordinate system of the image in the restricted image region is projection-converted into a coordinate system of an image of an output target. In the meanwhile, in the image with a wide angle of view, a coordinate system of an image in an out-of-restriction image region, which is outside the restricted image region, is not projection-converted into the coordinate system of the image of the output target. According to the processing as described above, only the coordinate system of the image within the restricted image region is projection-converted into the coordinate system of the image of the output target, and thus the false color and the missing region never occur. Therefore, it is possible to improve the immersiveness of the user viewing the image. In the following, details of the present disclosure are described.

### First Embodiment

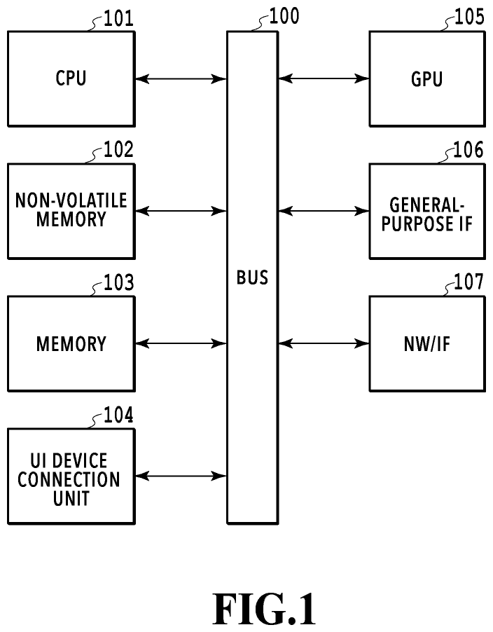

An example of converting the fisheye image into the equidistant cylindrical image is described. In the following, a configuration of a system is described with reference to FIG. 1. FIG. 1 is a diagram describing a system configuration of an image processing apparatus. An image processing system includes a bus 100, a CPU 101, a non-volatile memory 102, a memory 103, a user interface (UI) device connection unit 104, a GPU 105, a general-purpose interface (IF) 106, and a network (NW)/IF 107. The CPU 101, the non-volatile memory 102, the memory 103, the UI device connection unit 104, the GPU 105, the general-purpose IF 106, and the NW/IF 107 are connected via the bus 100. The bus 100 is a communication path to transmit various data or various types of control information. The CPU 101 controls the overall image processing system by executing various types of processing defined by software, applications, programs, and the like as needed. The CPU 101 can also execute various types of image processing by executing various types of processing defined by software, applications, programs, and the like as needed. The non-volatile memory 102 is a secondary storage region storing software, applications, and programs. Additionally, the non-volatile memory 102 is also a secondary storage region storing various data to execute various types of processing defined by software, an application, a program, and the like. The memory 103 is a temporary storage region structuring an execution environment of various types of processing defined by software, applications, programs, and the like. Specifically, the memory 103 loads the software, the applications, the programs, and the various data stored in the non-volatile memory 102 in a case of activating the image processing apparatus. Additionally, the memory 103 temporarily stores an image obtained by various types of processing and an image generated by various types of processing. That is, the memory 103 functions as a working area of the CPU 101. The UI device connection unit 104 functions as an interface of an input and output device such as a keyboard, a mouse, and a display. The GPU 105 executes image processing. The GPU 105 outputs an execution result of the image processing to the outside. An output destination of the GPU 105 is at least either one of the HMD and the display. The general-purpose IF 106 functions as an interface of a capture device. For example, a use case where the capture device is connected between an image capturing apparatus and the general-purpose IF 106 is assumed. Under the assumption, a camera image captured by the image capturing apparatus is supplied to the general-purpose IF 106 via the capture device. Thus, the image processing apparatus can obtain the camera image captured by the image capturing apparatus. Alternatively, a use case where the capture device is connected between a video camera and the general-purpose IF 106 is assumed. Under the assumption, a video signal captured by the video camera is supplied to the general-purpose IF 106 via the capture device. Thus, the image processing apparatus can obtain the video signal captured by the video camera. The NW/IF 107 is an interface that can input and output various data via a network. A communication medium for the connection between the NW/IF 107 and the network may be a wired medium or may be a wireless medium. Thus, in the present embodiment, the image may be inputted to the image processing apparatus via any one of the non-volatile memory 102, the general-purpose IF 106, and the NW/IF 107. Note that, in the present embodiment, the image stored in the memory 103 is assumed to be formed of a floating-point RGB value unless otherwise stated. Additionally, it is described that the image stored in the memory 103 is implicitly converted into a data format conforming to the purpose in a case where the image is inputted and outputted as a file or outputted to the outside.

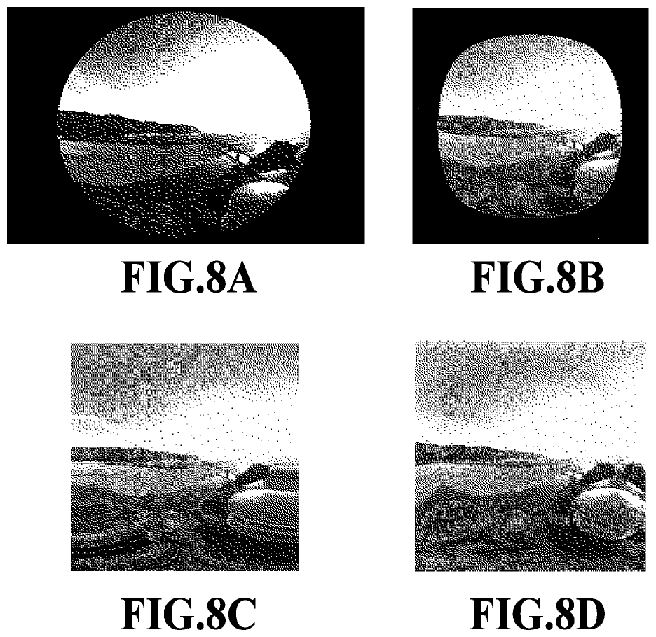

Additionally, a use case where an image sensor in the present embodiment has the pixel number of 4300 as the height and 2400 as the width, and the pixel number of the captured image is also 4300 as the height and 2400 as the width, for example, is assumed. Moreover, in the use case, the fisheye lens is the circular fisheye lens for the equidistance projection, and the effective image height of the lens that can assure the image quality is assumed to be 72°. Therefore, the effective image height of 72° is set within a range of an image circle. That is, the effective image height of 72° is set within the image circle that can secure the optical performance. Here, a deviation of the center of the image circle of the fisheye lens is described with reference to FIG. 8. FIGS. 8A, 8B, 8C, and 8D are diagrams illustrating an example of the fisheye image and the equidistant cylindrical image. FIG. 8A is a diagram illustrating an example of the fisheye image captured by using the fisheye lens. FIG. 8B is a diagram illustrating an example of the equidistant cylindrical image obtained by projection-converting the fisheye image in FIG. 8A. FIG. 8C is a diagram illustrating an example of the equidistant cylindrical image that is obtained by restricting an image region as a target of the projection conversion by a condition set in advance, compared to the equidistant cylindrical image in FIG. 8B. FIG. 8D is a diagram illustrating an example of the equidistant cylindrical image that is obtained by restricting the image region as the target of the projection conversion by another condition, compared to the equidistant cylindrical image in FIG. 8C.

In some cases, the center of the image circle of the fisheye lens is deviated due to an attachment error, a manufacturing error, and the like of the fisheye lens and the image sensor. In the present embodiment, the deviation is assumed within a range of +1°. In a case where the center of the image circle of the fisheye lens is deviated, an image with the image region exceeding the effective image height of the fisheye lens is captured by the image sensor. However, the false color tends to occur in the image region exceeding the effective image height of the fisheye lens due to aberration and the like. Note that, it is possible to correct the deviation of the center of the image circle of the fisheye lens by calculating a calibration parameter by calibration and correcting the position of the fisheye image. The calibration parameter in the present embodiment is assumed to be an external parameter, an internal parameter, and a distortion correction parameter of the image capturing apparatus. In the present embodiment, an example in which the equidistant cylindrical image is generated by the projection conversion from the fisheye image is described. In a case of the projection conversion as described above, it is possible to correct the deviation of the center of the image circle of the fisheye lens by generating the fisheye image to which the calibration parameter is reflected in advance. Additionally, in a case where the equidistant cylindrical image is generated by the projection conversion from the fisheye image, it is possible to correct the deviation of the center of the image circle of the fisheye lens by reflecting the calibration parameter. Hereinafter, a distance from the center of the image circle of the fisheye lens on which the calibration has been performed is referred to as a moving radius, and an angle of the moving radius rotating about an optical axis of the fisheye lens is referred to as an angle of deviation.

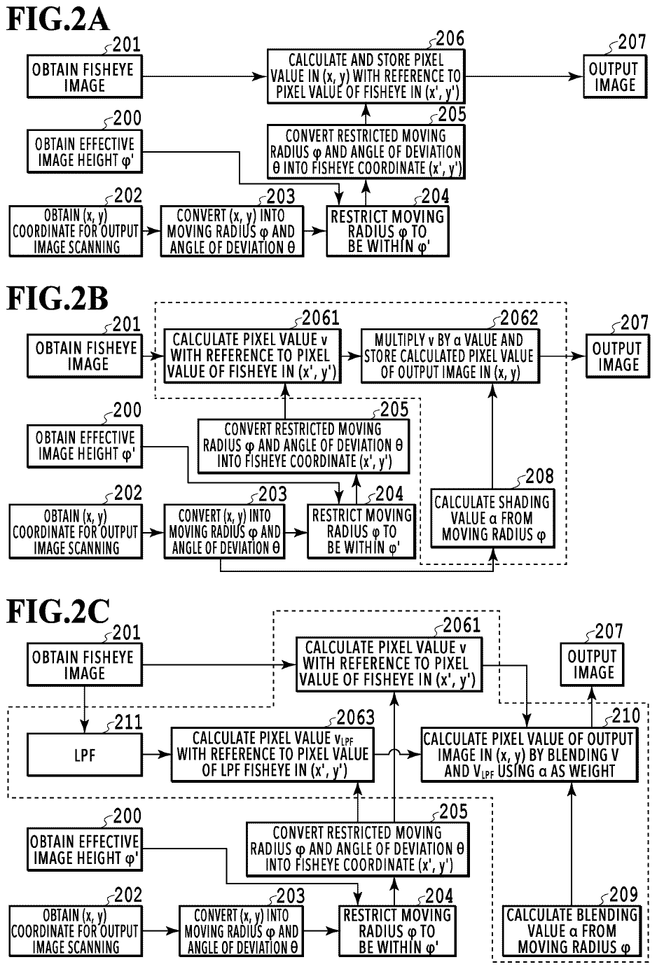

In the following, an example in which the equidistant cylindrical image with an angle of view of 180° is generated and outputted from the fisheye image is described. FIGS. 2A, 2B, and 2C are block diagrams describing conversion from the fisheye image into the equidistant cylindrical image with an angle of view of 180°. Each block in FIG. 2 may be either of a circuit or a conceptual processing block processed by the CPU 101. FIG. 2A is a diagram describing processing of the projection conversion into the equidistant cylindrical image in the first embodiment. FIG. 2B is a diagram describing processing of the projection conversion into the equidistant cylindrical image in a second embodiment. FIG. 2C is a diagram describing processing of the projection conversion into the equidistant cylindrical image in a third embodiment. FIGS. 2B and 2C are used to describe the corresponding embodiments, respectively.

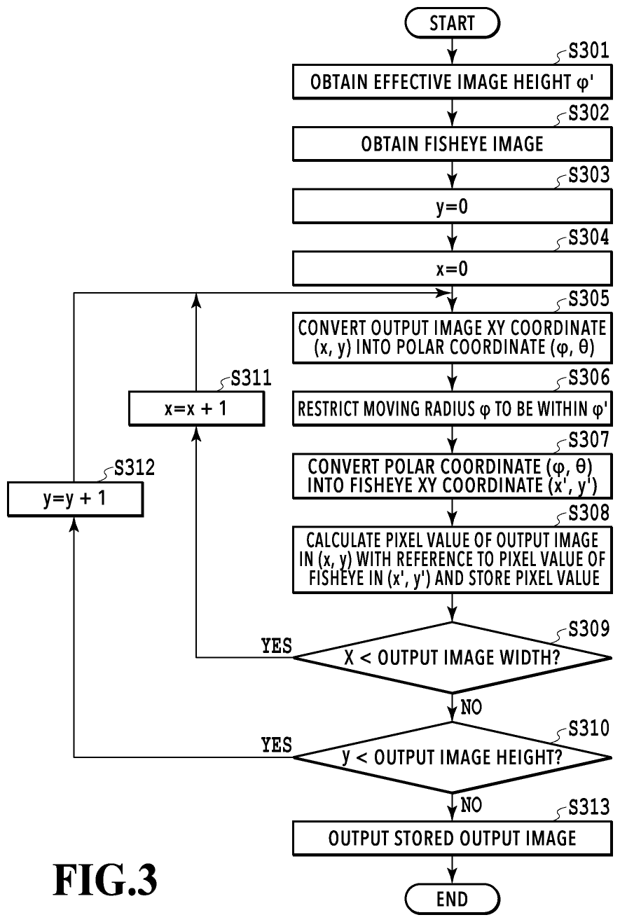

FIG. 3 is a flowchart describing the projection conversion from the fisheye image into the equidistant cylindrical image with an angle of view of 180° according to the first embodiment. In the following, details of the processing executed by the image processing apparatus are described in detail with reference to FIGS. 2A and 3. The processing illustrated in FIG. 3 is implemented with the CPU 101 executing a program deployed in the memory 103. The processing illustrated in FIG. 3 is executed in a timing of starting the processing of the projection conversion. Note that, a part of or all the functions of the steps in FIG. 3 may be implemented by hardware such as an ASIC or an electronic circuit. A symbol “S” in the description of each processing means that it is a step in the flowchart. Additionally, it is also possible to implement the processing illustrated in FIG. 3 as a configuration of cloud computing that shares one function by multiple resources and performs processing in cooperation via the Internet as long as the processing implements a function of each block in FIG. 2A.

Hereinafter, the processing of each block in FIG. 2A and the processing in each step in FIG. 3 are described in association with each other. Additionally, details of the processing are similar to the processing in each step in FIG. 3; for this reason, the details are described later with reference to FIG. 3. Each arrow in FIG. 2 represents a transmission direction of various data between the blocks.

FIG. 2A illustrates an effective image height obtainment unit 200, a fisheye image obtainment unit 201, a coordinate obtainment unit 202, a first coordinate conversion unit 203, a restriction unit 204, a second coordinate conversion unit 205, a pixel value calculation unit 206, and an image output unit 207. Processing executed by the effective image height obtainment unit 200 corresponds to the processing in S301 in FIG. 3. Processing executed by the fisheye image obtainment unit 201 corresponds to the processing in S302 in FIG. 3. Processing executed by the coordinate obtainment unit 202 corresponds to the processing in S303 to S312 in FIG. 3.

Note that, the coordinate obtainment unit 202 executes processing of obtaining XY coordinate (x, y) for scanning of the output image. In the processing in S303 to S312 in FIG. 3, the coordinate (x, y) is calculated by scanning a focused pixel of the output image. In the present embodiment, the output image that is the image as the output target is the equidistant cylindrical image. Specifically, a value identified by the XY coordinate (x, y) is calculated such that the uppermost line of the equidistant cylindrical image is scanned to the left or the right, and once the scanning of one line is done, the subsequent line is scanned again to the left or the right. The first coordinate conversion unit 203 executes processing of converting the XY coordinate (x, y) into polar coordinate (φ, θ), where φ is the moving radius, and θ is the angle of deviation (S305). That is, the projection conversion is performed from an orthogonal coordinate system into a polar coordinate system. The restriction unit 204 executes processing of restricting the moving radius φ to be within φ ′ (S306). The second coordinate conversion unit 205 executes processing of converting the restricted moving radius φ and angle of deviation θ into fisheye XY coordinate (x′, y′) (S307). That is, the projection conversion is performed from the polar coordinate system into the orthogonal coordinate system. With reference to a pixel value of the fisheye image identified by the fisheye XY coordinate (x′, y′), the pixel value calculation unit 206 executes processing of calculating a pixel value of the output image identified by the XY coordinate (x, y) and executes processing of storing the pixel value (S308). The image output unit 207 outputs the stored output image (S313).

Hereinafter, the processing in each step in FIG. 3 is described. Unless otherwise stated, each step is executed in the order represented by the arrow in FIG. 2A; however, as long as it is independent from an input and output relationship of the data in each step, the step may be executed in a different order. It is assumed that the CPU 101 executes each step. The output image in the following description indicates the equidistant cylindrical image. Additionally, with double loop executed by the processing in each step from S303 to S312, the pixel is scanned in the coordinate system of the output target, and the pixel value of the output image is calculated. Hereinafter, details of the processing in each step are described.

In S301, the CPU 101 obtains a threshold φ′ of the effective image height. In the present embodiment, it is assumed that the maximum image height that does not cause the false color is obtained as the threshold φ′ of the effective image height. The maximum image height that does not cause the false color can be obtained from a design value, obtained by measuring in advance, and obtained by detecting from the input image. Specifically, an image quality assurance range is determined in advance in the optical design of the fisheye lens. However, in reality, an image exceeding the image height may be projected on an image plane. For example, the center of the optical axis of the fisheye lens may be deviated during the image processing. In this case, the image circle is also deviated from a predetermined position. Therefore, in some cases, the image with the image region exceeding the effective image height of the fisheye lens is captured by the image sensor. However, the false color tends to occur in the image region exceeding the effective image height of the fisheye lens. The occurrence of the false color is caused by, for example, chromatic aberration of magnification, axial chromatic aberration, and the like. In general, the greater the image height, the greater the aberration. The greater the aberration, the stronger the color misregistration observed in a portion of an edge of the image. The color misregistration is a blur of red color (R) or a blue color (B). For example, in a case where the pixel of one color exceeds the pixel number of the one color set in advance and protrudes from a region of the pixel of the one color to a region of the pixel of another color, it is assumed that the false color occurs. Under the assumption, the maximum image height that does not cause the false color means an image height that is within a range that the pixel of the one color does not exceed and protrude from the pixel number set in advance. Additionally, for example, a case where only B of RGB exceeds 30% is also treated as the false color. That is, the range is determined in advance, and the maximum value that does not exceed the determined range is the effective image height. Note that, the image height is determined by a distance from a start point that is the center of image capturing, which is an intersection point of the center of the optical axis of the fisheye lens and the image plane of the image capturing optical system including the fisheye lens, in a radiation direction of the moving radius indicating an element of the polar coordinate in a case of representing each pixel position in the image plane by the polar coordinate.

Alternatively, in the present embodiment, an image height that allows a deviation of a wavelength representing green of rays of specific wavelengths representing the red color (R) and the blue color (B) to be one pixel or smaller may be the effective image height. The wavelengths representing the red color (R), the blue color (B), and the green color (G) are 700.0 (nm), 546 (nm), and 436 (nm), respectively, for example; however, the wavelengths may be adjusted as needed according to the characteristics of a color filter of the image sensor. Additionally, it is possible to simulate the above-described wavelengths by a lens shape, a lens material, or a combination of the lens shape and the lens material. Although an acceptable value of the deviation is one pixel in the present embodiment, for example, it is not limited thereto. The higher the resolution of the image sensor, the higher the manufacturing cost of the lens, and the less the false color the fisheye lens produces, the higher the manufacturing cost. For this reason, the acceptable value of the deviation may be set considering the cost.

Alternatively, it is also possible to determine the maximum image height, with which the occurrence of the false color can be accepted, by measurement. For example, the color misregistration that can be said as an occurrence amount of the false color may be measured. Specifically, the color misregistration may be measured by a color filter having spectral characteristics that allows only a wavelength region of a predetermined width in which the center is a peak value of each wavelength region of R, B, and G to pass therethrough.

Alternatively, it may be considered that aberration correction has been performed to determine the effective image height from the design value or the measurement value. The color misregistration is not suppressed completely even with the aberration correction. For this reason, an image height with which the aberration that has not been corrected can be accepted may be the effective image height.

In S302, the CPU 101 obtains the fisheye image. In S303, the CPU 101 initializes a variable y to 0. The variable y is perpendicular coordinate (a Y coordinate) of the output image. In S304, the CPU 101 initializes a variable x to 0. The variable x is horizontal coordinate (an X coordinate) of the output image. In S305, the CPU 101 converts the XY coordinate (x, y) of the output image into the polar coordinate (φ, θ). That is, the coordinate system is projection-converted from the orthogonal coordinate system into the polar coordinate system. The projection conversion is performed according to the following expression.

$$( \begin{matrix}ϕ \\ θ\end{matrix} ) = ( \begin{matrix}\frac{x - {w}_{out} / 2}{{w}_{out}} π \\ \frac{y - {w}_{out} / 2}{{h}_{out}} π\end{matrix} ) \qquad ( 1 )$$

Specifically, wₒᵤₜ and hₒᵤₜ represent a width and a height of the equidistant cylindrical image that is the output image, respectively. In Expression (1), the center of the equidistant cylindrical image corresponds to φ=0, θ=0. A unit of φ and θ is radian. Additionally, φ represents the moving radius, and θ represents the angle of deviation.

In S306, the CPU 101 restricts the moving radius φ to be within the threshold φ′ of the effective image height. As the threshold φ′ of the effective image height, a value equal to or smaller than the effective image height that can assure the image quality as the fisheye lens is set. In the present embodiment, it is described that the threshold φ′ of the effective image height is 70°. The restricted value in the present embodiment can be calculated under the following condition.

$${ϕ}_{new} = \{ \begin{matrix}ϕ & if ϕ < {ϕ}^{′} \\ {ϕ}^{′} & else\end{matrix} \qquad ( 2 )$$

In the following, a use case where φ is replaced with φ_{new} is described.

In S307, the CPU 101 converts the polar coordinate (φ, θ) into the fisheye XY coordinate (x′, y′). That is, the coordinate system is projection-converted from the polar coordinate system into the orthogonal coordinate system. This corresponds to inverse transformation of Expression (1).

$$( \begin{matrix}{x}^{′} \\ {y}^{′}\end{matrix} ) = ( \begin{matrix}k ( \frac{ϕcos ( ϕ )}{π} ) \times width + width / 2 \\ k ( \frac{ϕsin ( ϕ )}{π} \times height + height / 2\end{matrix} ) \qquad ( 3 )$$

Specifically, k is a value obtained by normalizing the moving radius φ of the image circle inscribed in the image sensor, and in the present embodiment, the image circle of 72° is inscribed in the image sensor. In this case, k=90/72.

In S308, with reference to the pixel value of the fisheye image identified by the fisheye XY coordinate (x′, y′), the CPU 101 calculates the pixel value of the output image identified by the XY coordinate (x, y) and stores the calculated pixel value. Note that, the pixel value of the fisheye image identified by the fisheye XY coordinate (x′, y′) is a real number. Therefore, interpolation processing (in the following, referring to as bilinear interpolation) by a BiLinear method is executed on the pixel values of neighboring four points expressed in integer coordinate. The pixel values on which the interpolation processing has been executed are sequentially stored in the memory 103. At the time point of completing the scanning of all the pixels, the pixel value of the output image is in a stored state by being transferred from the memory 103 to the non-volatile memory 102. Note that, the interpolation processing is not limited to the bilinear interpolation. For example, the interpolation processing by a BiCubic method or a Lanczos method may be applied.

In S309, the CPU 101 determines whether x<the output image width, and if it is true, the processing proceeds to S311, and if it is false, the processing proceeds to S310.

In S310, the CPU 101 determines whether y<the output image height, and if it is true, the processing proceeds to S312, and if it is false, the processing proceeds to S313.

In S311, the CPU 101 increments x. Thereafter, the processing proceeds to S305. In S312, the CPU 101 increments y. Thereafter, the processing proceeds to S305. In S313, the CPU 101 outputs the stored output image. In the present embodiment, the image may be outputted to the non-volatile memory 102 in file units.

Incidentally, in a case where the black portion outside the image circle of the circumferential fisheye image is left, or a region that is not captured in the image is painted a predetermined color, for example, black, and the equidistant cylindrical image with an angle of view of 180° is generated, the following occurs. That is, in the generated equidistant cylindrical image, a region with a high image height is black as illustrated in FIG. 8B. Therefore, in a case of viewing with the HMD of a display angle of view of 100°, once the user shakes their own neck horizontally at 25°, for example, the black region is moved to the end of the field of view, and the immersiveness is diminished. However, according to the present embodiment, the moving radius is restricted within the threshold φ′ of the effective image height (70°)C. According to the processing, the equidistant cylindrical image is generated by copying the pixel value with the image height restricted to be smaller than of 70° to the pixel value with the image height of 70° or greater. The image restricted as described above is as illustrated in FIG. 8C.

### (Output Image Example)

### (Use Case i: Copying of End Portion)

FIG. 8C illustrates the image generated by copying the end portion of the image region with the threshold φ′ of the effective image height to the out-of-restriction image region that is the image region identified by the image height equal to or greater than the effective image height as identified by Expression (2). That is, the CPU 101 generates the output image by copying the end portion of the image region with the threshold φ′ of the effective image height to the out-of-restriction image region and outputs the generated output image to be displayed. The output image in this process includes a partial image formed in the restricted image region and a partial image formed in the out-of-restriction image region around the restricted image region. In the restricted image region, the image region in the image with a wide angle of view that is used for the projection conversion is restricted. The above-described restricted image region is an image region identified by the image height smaller than the effective image height. The partial image formed in the out-of-restriction image region is a partial image generated by copying the image of the end portion of the image region with the threshold φ′ of the effective image height.

Therefore, even in a case of the image region with the high image height, the image region is never painted black. Thus, even in a case where the user shakes their own neck horizontally at 25°, the black portion does not appear at the end of the field of view of the user. Additionally, in general, the resolution of the end of the field of view of a human tends to be low. Therefore, even in a case where the correct image does not appear at the end, the user is unlikely to feel the diminishment of the immersiveness. Therefore, the present embodiment has sufficient effects. Moreover, in a case where the image region outside the image circle is painted black, jaggies tend to occur at the boundary. However, in the present embodiment, since there is no boundary from the black portion in the first place, the jaggies are unlikely to occur. The above-described jaggies are likely to occur in a case of reducing the interpolation accuracy in a case of the equidistant cylindrical conversion, or reducing the accuracy of the coordinate conversion particularly, for the purpose of increasing the speed of the processing; however, in the first place, the image region outside the image circle is not painted black.

In other words, in the present embodiment, the image with a wide angle of view in which the angle of view exceeds a predetermined value is obtained. The image region in the image with a wide angle of view that is used for the projection conversion is restricted to the restricted image region. In the image with a wide angle of view, the coordinate system of the image in the restricted image region is projection-converted into the coordinate system of the image of the output target. According to the processing as described above, the coordinate system of the image in the restricted image region is projection-converted into the coordinate system of the image of the output target. Therefore, the false color or the missing region never occurs. Accordingly, it is possible to improve the immersiveness of the user viewing the image. Additionally, the coordinate system of the image in the out-of-restriction image region outside the restricted image region is not projection-converted into the coordinate system of the image of the output target. According to the processing as described above, only the coordinate system of the image within the restricted image region is projection-converted into the coordinate system of the image of the output target. For this reason, the false color or the missing region never occurs. Moreover, as the threshold that makes it possible to identify the restricted image region and the out-of-restriction image region, the effective image height, which is an upper limit value of the image height indicating an imaging height from the center of the optical axis of the image capturing optical system used to capture the image with a wide angle of view, is obtained. According to the processing as described above, it is possible to distinguish the restricted image region and the out-of-restriction image region by using the image height as a parameter. Furthermore, in the image region including the image with a wide angle of view, the image region identified by the image height smaller than the effective image height is the restricted image region, and the image region identified by the image height equal to or greater than the effective image height is the out-of-restriction image region. The out-of-restriction image region may include the image region in which the false color occurs.

Additionally, in the present embodiment, the threshold φ′ of the effective image height is a value smaller than the effective image height of the fisheye lens that can assure the image quality. Therefore, the false color is never mixed in the equidistant cylindrical image.

Moreover, in S306 of the present embodiment, although a restriction method is restricted according to Expression (1) described above, so that the moving radius φ is restricted to be within the threshold φ′ of the effective image height, it is not limited thereto. For example, the restriction may be performed under the following condition.

$${ϕ}_{new} = \{ \begin{matrix}ϕ & if ϕ < {ϕ}^{′} \\ {ϕ}^{′} - ( ϕ - {ϕ}^{′} ) & else\end{matrix} \qquad ( 4 )$$

Under the condition of Expression (4), the equidistant cylindrical image in which the image turning back to the outer side of the threshold φ′ of the effective image height based on the threshold φ′ of the effective image height spreads radially is generated. The image generated according to the condition of Expression (4) is as illustrated in FIG. 8D.

### (Output Image Example)

### (Use Case ii: Copying of Turning-Back End Portion)

FIG. 8D illustrates the image generated by turning back the end portion of the image region with the threshold φ′ of the effective image height and copying the turning-back end portion to the out-of-restriction image region as identified by Expression (4). That is, the CPU 101 generates the output image by turning back the end portion of the image region with the threshold φ′ of the effective image height and copying the turning-back end portion to the out-of-restriction image region and outputs the generated output image to be displayed. The output image in this case includes a partial image formed in the restricted image region and a partial image formed in the out-of-restriction image region around the restricted image region. In the restricted image region, the image region in the image with a wide angle of view that is used for the projection conversion is restricted. The above-described restricted image region is an image region identified by the image height smaller than the effective image height. The partial image formed in the out-of-restriction image region is the partial image generated by copying the image of the turning-back end portion of the image region with the threshold φ′ of the effective image height. According to the output image including the partial image formed in the above-described restricted image region, it is possible to generate the equidistant cylindrical image in which the turning-back image spreads radially; therefore, it is possible to further improve the immersiveness of the user.

Note that, although the description is provided assuming that a single eye fisheye image is applied in the present embodiment, it is not limited thereto. A stereo fisheye image and the equidistant cylindrical image of 360° that is converted from two or more fisheye images may be applied.

Additionally, although a case where the effective image height of the fisheye lens is 72° is assumed and described in the present embodiment, it is not limited thereto. For example, even in a case where the effective image height of the fisheye lens is 90°, the effect is obtained. In the present embodiment, also in a case where the correction amount by the calibration is great, or a case where the correction amount to correct hand shake in the image is great, the following may occur if the moving radius is not restricted. That is, a region in which no image is captured, which is referred to as vignetting, needs to be referred for calculation. Usually, the vignetting region is painted black; however, with use of the processing described in the present embodiment, it is unnecessary to paint the vignetting region black.

Moreover, although it is described that the calibration is executed in the present embodiment, the calibration is not necessarily required. Note that, in this case, a single threshold φ′ of the effective image height cannot be set. Therefore, instead of the processing in S306, the threshold φ′ of the effective image height may be set for each angle of deviation θ as the following expression.

$${ϕ}^{′} = {f}_{ϕ} ( θ ) \qquad ( 5 )$$

A function of Expression (5) may be prepared in advance based on the measurement value and the lens design value. In the present embodiment, it is described that the moving radius φ is restricted in a case of converting the fisheye image into the equidistant cylindrical image; however, the output image may be the fisheye image. In this case, considering the size of the image circle in terms of an angle, the image circle of the fisheye image as the output image is greater than the image circle of the fisheye image as the input image. Processing of copying the pixel within the threshold φ′ of the effective image height to the pixel in the image region outside the threshold φ′ of the effective image height of the fisheye image is performed, and the moving radius φ of the copied pixel is restricted. Therefore, it is possible to execute the processing according to the embodiment of the present disclosure. Note that, in the image, although the pixel spreads radially, the projection type is still the equidistance projection. Therefore, even in a case where the image is projection-converted into the equidistant cylindrical image, it is possible to create a similar image as the equidistant cylindrical image converted by the processing in FIG. 3.

Additionally, although it is described that the coordinate conversion using a trigonometric function is calculated for each pixel of the equidistant cylindrical image in the present embodiment, it is not limited thereto. The calculation may be performed with low frequency, and the value may be linearly interpolated. That is, for the purpose of increasing the speed of the processing, the entirety may be calculated with low frequency at first, and thereafter the details may be calculated with high frequency. In this case, the coordinate conversion accuracy is reduced; however, as described above, no jaggies occur in the boundary portion, and therefore the application effect of the present embodiment is higher.

### Second Embodiment

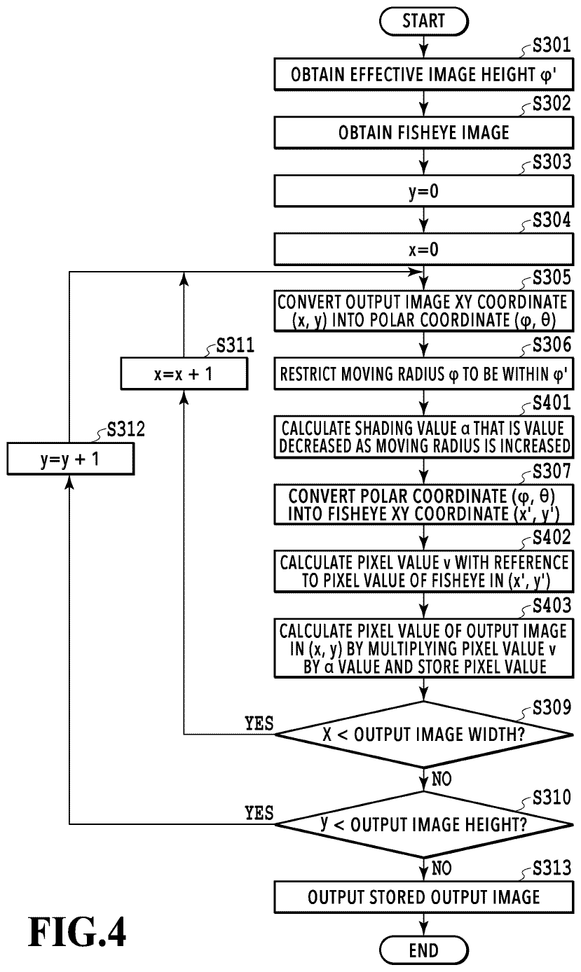

The equidistant cylindrical conversion along with shading processing is described with reference to FIGS. 2B and 4. FIG. 4 is a flowchart describing the projection conversion from the fisheye image into the equidistant cylindrical image with an angle of view of 180° according to the second embodiment. In the following, details of the processing executed by the image processing apparatus are described with reference to FIGS. 2B and 4. The processing illustrated in FIG. 4 is implemented with the CPU 101 executing a program deployed in the memory 103. The processing illustrated in FIG. 4 is executed in a timing of starting the processing of the projection conversion. Note that, a part of or all the functions of the steps in FIG. 4 may be implemented by hardware such as an ASIC or an electronic circuit. A symbol “S” in the description of each processing means that it is a step in the flowchart. Additionally, it is also possible to implement the processing illustrated in FIG. 4 as a configuration of cloud computing that shares one function by multiple resources and performs processing in cooperation via the Internet as long as the processing implements a function of each block in FIG. 2B. Moreover, in a case where there is no change or specific description, the description of the processing is equivalent to the descriptions of FIGS. 2A and 3 in the first embodiment.

Hereinafter, the processing of each block in FIG. 2A and the processing in each step in FIG. 4 are described in association with each other. Additionally, details of the processing are similar to the processing in each step in FIG. 4; for this reason, the details are described later with reference to FIG. 4.

In FIG. 2B, comparing with FIG. 2A, a shading value calculation unit 208 and a pixel value calculation unit 2062 are added, and the pixel value calculation unit 206 is replaced with a pixel value calculation unit 2061. Processing executed by the shading value calculation unit 208 corresponds to processing in S401. Processing executed by the pixel value calculation unit 2061 corresponds to processing in S402. Processing executed by the pixel value calculation unit 2062 corresponds to processing in S403.

Hereinafter, the processing in each step in FIG. 4 that is different from FIG. 3 is mainly described. In S401, the CPU 101 calculates a shading value a that is decreased as the moving radius is increased. In the present embodiment, the shading value a is calculated according to the following expression.

$$α = \{ \begin{matrix}1 & if ϕ < {ϕ}_{1} \\ 0 & else if ϕ > {ϕ}_{2} \\ \frac{ϕ - {ϕ}_{1}}{{ϕ}_{2} - {ϕ}_{1}} & else\end{matrix} \qquad ( 6 )$$

Specifically, φ₁ represents a shading-starting moving radius with which the pixel value starts getting dark by shading, and φ₂ represents a shading-ending moving radius with which the pixel value becomes black by shading. At least φ₂ is a value greater than the threshold φ′ of the effective image height. In the present example, φ₁ is the same value as the effective image height. It is preferable to set φ₁ to the same value as the effective image height to prevent deterioration of the region in which the false color does not occur as much as possible. As long as the condition, 0<φ₁<φ₂, is satisfied, it is possible to perform the processing regardless of the value of φ₁.

In S402, the CPU 101 calculates a pixel value v with reference to the pixel value of the fisheye image identified by the fisheye XY coordinate (x′, y′). In S403, the CPU 101 calculates the pixel value of the output image identified by the XY coordinate (x, y) by multiplying the pixel value v by the a value and stores the calculated pixel value.

According to the present embodiment, shading is performed on the image region of the boundary around the effective image height. In the equidistant cylindrical image generated in the first embodiment, the image spreads radially. Therefore, in a case where the user views the equidistant cylindrical image generated in the first embodiment in a planar display, the user may feel uncomfortable. In the present embodiment, it is possible to reduce the uncomfortable feeling by gradually darkening the outer side. Additionally, in a case where the user views the HMD, it is possible to reduce the uncomfortable feeling caused because the user can see the black portion outside of the field of view of the user more than a case where the image region of the above-described boundary is colored in black immediately. Moreover, in the present embodiment in which shading is performed on the image region obtained by copying the outside of the effective image height threshold, the user can view the image more effectively without deterioration of the image within the effective image height caused by shading than a case of only shading a specific image region of the image.

### (Output Image Example)

### (Use Case iii: Copying and Shading of End Portion)

In other words, as identified by Expression (6), an image in which the pixel value is darkened as the moving radius φ is increased is generated between the shading-starting moving radius φ₁ and the shading-ending moving radius φ₂ in the out-of-restriction image region. That is, the CPU 101 generates the output image by copying the image in which the pixel value is darkened as the moving radius φ is increased between the shading-starting moving radius φ₁ and the shading-ending moving radius φ₂ and outputs the generated output image to be displayed. The output image in this process includes a partial image formed in the restricted image region and a partial image formed in the out-of-restriction image region around the restricted image region. In the restricted image region, the image region in the image with a wide angle of view that is used for the projection conversion is restricted. The above-described restricted image region is an image region identified by the image height smaller than the effective image height. The partial image formed in the out-of-restriction image region is a partial image generated by copying the image in which the pixel value is darkened as the moving radius φ is increased between the shading-starting moving radius φ₁ and the shading-ending moving radius φ₂. According to the output image including the partial image formed in the out-of-restriction image region as described above, it is possible to perform shading without reducing the effective angle of view. Therefore, it is possible to provide the user with further immersiveness. Here, the effective angle of view is described. The angle of view and the image height has correlation via the fisheye lens, and in the present embodiment, the angle of view corresponding to the effective image height is referred to as the effective angle of view hereinafter.

### (Output Image Example)

### (Use Case iv: Mirror-Copying and Shading of End Portion)

Note that, in the image shaded as described above, the out-of-restriction image region may be a partial image generated by copying the turning-back image of the end portion of the image region with the threshold φ′ of the effective image height. The partial image generated by copying the turning-back image of the end portion of the image region with the threshold φ′ of the effective image height may be an image in which the pixel value is darkened as the moving radius φ is increased between the shading-starting moving radius φ₁ and the shading-ending moving radius φ₂. In this case, the threshold φ′ of the effective image height is equal to the shading-starting moving radius φ₁, and the shading-ending moving radius φ₂ is greater than the shading-starting moving radius φ₁. That is, the output image may be a combination of that in the use case ii and the use case iii. According to the output image including the above-described partial image formed in the out-of-restriction image region, it is possible to perform shading on the equidistant cylindrical image in which the turning-back image spreads radially without reducing the effective angle of view. Therefore, it is possible to attenuate the image smoothly into black by preventing immediate change into black at the boundary of the effective angle of view. Additionally, it is possible to prevent shading on the effective angle of view. Accordingly, it is possible to provide the user with significant immersiveness.

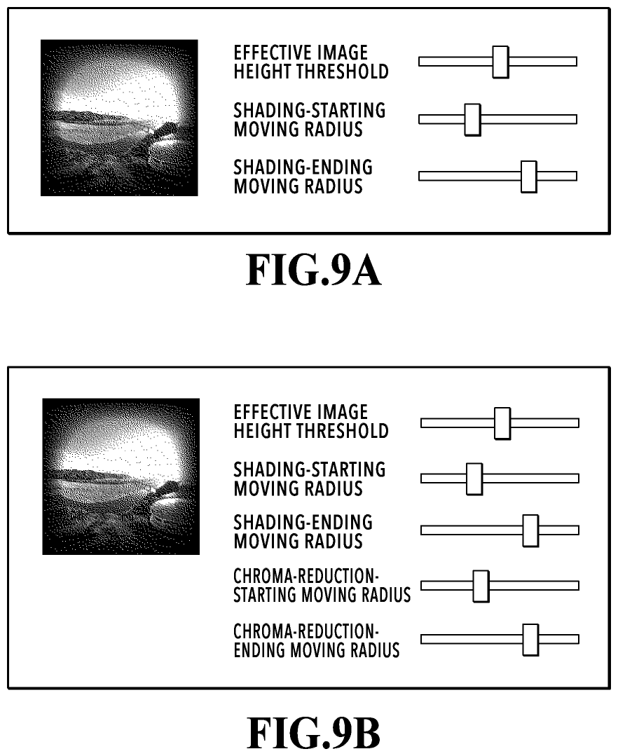

Additionally, although it is described that fixed values determined by the relative relationship with respect to the threshold φ′ of the effective image height determined by the fisheye lens are set as φ₁ and φ₂ in the present embodiment, it is not limited thereto. The thresholds φ₁ and φ₂ of the effective image height may be designated by the user. An example of a user interface (UI) to designate a parameter of the thresholds is described with reference to FIGS. 9A and 9B. FIGS. 9A and 9B are diagrams describing an example of the UI designating the equidistant cylindrical conversion parameter. FIGS. 9A and 9B include a preview image and a slider that can set a value. FIG. 9A is a diagram illustrating the slider corresponding to each of the threshold φ′ of the effective image height, the shading-starting moving radius φ₁, and the shading-ending moving radius φ₂. With each slider in FIG. 9A being adjusted, φ′, φ₁, and φ₂ are increased and decreased, and it is possible to generate the shaded equidistant cylindrical image in real time and display the image on the display. Note that, a video version thereof may also be outputted to the HMD. With each slider in FIG. 9A being adjusted, the user can determine the parameter for the equidistant cylindrical conversion while confirming the degree of the immersiveness.

### Third Embodiment

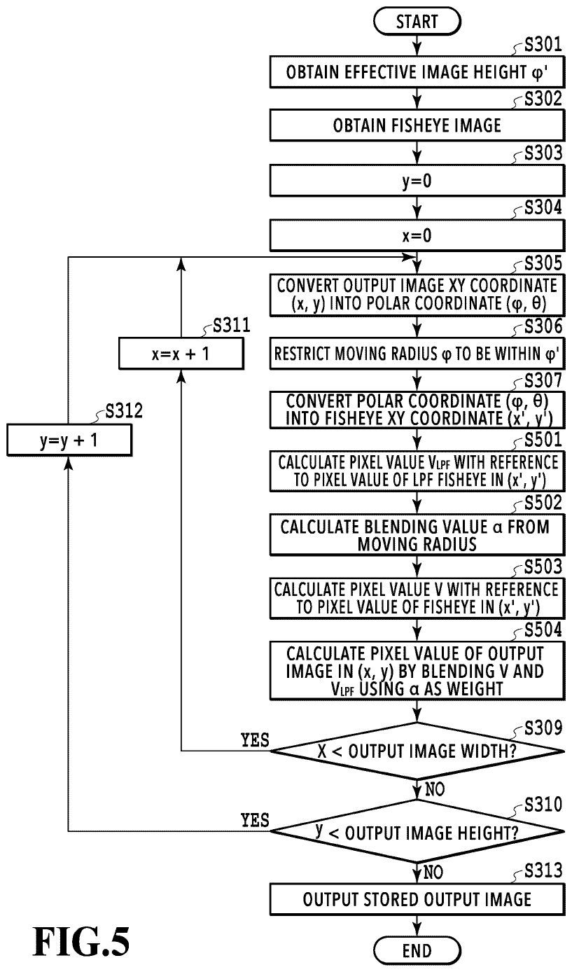

The equidistant cylindrical conversion along with smoothing processing is described with reference to FIGS. 2C and 5. FIG. 5 is a flowchart describing the projection conversion from the fisheye image into the equidistant cylindrical image with an angle of view of 180° according to the third embodiment. In the following, details of the processing executed by the image processing apparatus are described with reference to FIGS. 2C and 5. The processing illustrated in FIG. 5 is implemented with the CPU 101 executing a program deployed in the memory 103. The processing illustrated in FIG. 5 is executed in a timing of starting the processing of the projection conversion. Note that, a part of or all the functions of the steps in FIG. 5 may be implemented by hardware such as an ASIC or an electronic circuit. A symbol “S” in the description of each processing means that it is a step in the flowchart. Additionally, it is also possible to implement the processing illustrated in FIG. 5 as a configuration of cloud computing that shares one function by multiple resources and performs processing in cooperation via the Internet as long as the processing implements a function of each block in FIG. 2C. Moreover, in a case where there is no change or specific description, the description of the processing is equivalent to the descriptions of FIGS. 2A and 3 in the first embodiment.

Hereinafter, the processing of each block in FIG. 2C and the processing in each step in FIG. 5 are described in association with each other. Additionally, details of the processing are similar to the processing in each step in FIG. 5; for this reason, the details are described later with reference to FIG. 5. Note that, in the following description, the smoothing processing is expressed as a low-pass filter (LPF) processing.

In FIG. 2C, comparing with FIG. 2A, a blending value calculation unit 209, a blending unit 210, an LPF processing unit 211, and an LPF pixel value calculation unit 2063 are added. Additionally, the pixel value calculation unit 206 is replaced with the pixel value calculation unit 2061 and the LPF pixel value calculation unit 2063. Processing executed by the blending value calculation unit 209 corresponds to processing in S502. Processing executed by the pixel value calculation unit 2061 corresponds to processing in S503. Processing executed by the LPF pixel value calculation unit 2063 corresponds to processing in S501. Processing executed by the LPF processing unit 211 corresponds to processing in S501. Processing executed by the blending unit 210 corresponds to processing in S504.

Hereinafter, the processing in each step in FIG. 5 that is different from FIG. 3 is mainly described. In S501, the CPU 101 performs the LPF processing on the fisheye image and generates an LPF fisheye image. In the present embodiment, the processing is performed with a Gaussian filter of σ=5 and a radius of 15. In addition, the CPU 101 calculates a pixel value v_{LPF} with reference to the pixel value of the LPF fisheye image identified by the fisheye XY coordinate (x′, y′). In S502, the CPU 101 calculates a blending value a from the moving radius. Specifically, a is a value that is decreased as the moving radius is increased and is calculated according to Expression (6). Additionally, φ₁ represents the moving radius with which the blending starts, and φ₂ represents the moving radius with which the image is switched to the LPF fisheye image. In S503, the CPU 101 calculates the pixel value v with reference to the pixel value of the fisheye image identified by the fisheye XY coordinate (x′, y′). In S504, the CPU 101 calculates the pixel value of the output image identified by the XY coordinate (x, y) by blending the pixel value v and the pixel value v_{LPF} using α as a weight and stores the calculated pixel value. In the present embodiment, a value v_{new} obtained by blending is calculated according to the following expression.

$${v}_{n e w} = α v + ( 1 - α ) {v}_{L P F} \qquad ( 7 )$$

In Expression (7), as the moving radius (the image height) is increased, a is decreased, and the pixel value with a greater degree of smoothing can be calculated. In the first embodiment, in FIGS. 8C and 8D, since copying is performed radially, the user may feel uncomfortable due to the radial image more as the moving radius is greater. According to the present embodiment, with blending that increases a ratio of the LPF image more as the moving radius is greater, it is possible to obtain the equidistant cylindrical image that is smoothed in a simulated manner, in other words, having a low contrast. Therefore, it is possible to reduce the uncomfortable feeling described above. Note that, in the present embodiment, the shading value a described in the second embodiment may be used together. In this case, the blending value a may be the same value as the shading value a in the second embodiment or may be calculated individually. Additionally, as with the second embodiment, the user may set φ₁ and φ₂ via the UI as the blending value a.

### (Output Image Example)

### (Use Case v: Copying, Shading, and LPF of End Portion)

In other words, as identified by Expression (6) and Expression (7), an image in which the ratio of the LPF image is increased as the moving radius φ is increased is generated between the moving radius φ₁ with which blending is started and the moving radius φ₂ with which the image is switched to the LPF fisheye image in the out-of-restriction image region. That is, the CPU 101 generates the output image by copying the image in which the ratio of the LPF image is increased as the moving radius φ is increased between the moving radius φ₁ with which blending is started and the moving radius φ₂ with which the image is switched to the LPF fisheye image in the out-of-restriction image region. The CPU 101 outputs the generated output image to be displayed. The output image in this process includes a partial image formed in the restricted image region and a partial image formed in the out-of-restriction image region around the restricted image region. In the restricted image region, the image region in the image with a wide angle of view that is used for the projection conversion is restricted. The above-described restricted image region is an image region identified by the image height smaller than the effective image height. The partial image formed in the out-of-restriction image region is a partial image generated by copying the image in which the ratio of the LPF image is increased between the moving radius φ₁ with which blending is started and the moving radius φ₂ with which the image is switched to the LPF fisheye image. According to the output image including the partial image formed in the out-of-restriction image region as described above, the following actions and effects are obtained.

That is, it is possible to generate the pixel value that is gradually blurred from the center of the image circle toward the outer side along the radiation direction of the moving radius in the image region created by copying in the out-of-restriction image region. Therefore, it is possible to make roughness in the out-of-restriction image region inconspicuous. Accordingly, it is possible to provide the user with particularly significant immersiveness.

Note that, although the Gaussian filter in the present embodiment has σ=5 and a radius of 15, it is not limited thereto. For example, a configuration that allows the user to perform setting by using the UI may be applied. Additionally, in the present embodiment, it is described that the LPF processing is performed on the fisheye image used as the input image. However, a similar effect is obtained even in a case of applying a configuration in which the equidistant cylindrical image as the output image is created once, the LPF processing is performed on the equidistant cylindrical image, and the equidistant cylindrical image subjected to the LPF processing and the equidistant cylindrical image not subjected to the LPF processing are blended by using the blending value a determined according to the moving radius.

### Fourth Embodiment

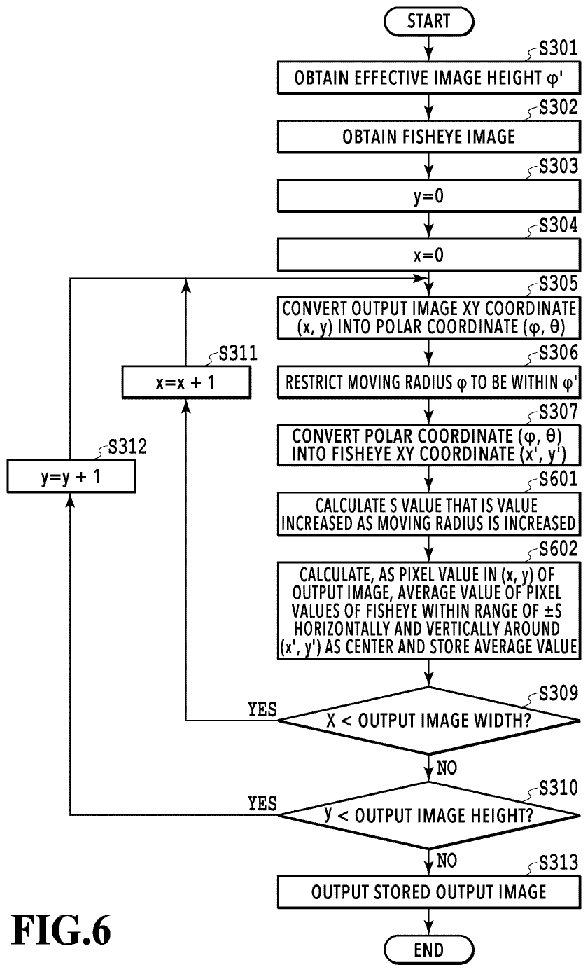

The equidistant cylindrical conversion in which the degree of smoothing is increased as the moving radius is increased is described with reference to FIG. 6. FIG. 6 is a flowchart describing the projection conversion from the fisheye image into the equidistant cylindrical image with an angle of view of 180° according to the fourth embodiment. In the following, details of the processing executed by the image processing apparatus are described with reference to FIG. 6. The processing illustrated in FIG. 6 is implemented with the CPU 101 executing a program deployed in the memory 103. The processing illustrated in FIG. 6 is executed in a timing of starting the processing of the projection conversion. Note that, a part of or all the functions of the steps in FIG. 6 may be implemented by hardware such as an ASIC or an electronic circuit. A symbol “S” in the description of each processing means that it is a step in the flowchart. Additionally, it is also possible to implement the processing illustrated in FIG. 6 as a configuration of cloud computing that shares one function by multiple resources and performs processing in cooperation via the Internet. Additionally, in a case where there is no change or specific description, the description of the processing is equivalent to the description of FIG. 3 in the first embodiment.

In the processing illustrated in FIG. 6, comparing with the processing illustrated in FIG. 3, processing in S601 is added, and the processing in S308 is replaced with the processing in S602. In S601, the CPU 101 calculates an S value that is increased as the moving radius is increased according to the following expression.

$$S = \{ \begin{matrix}15 & if ϕ < {ϕ}_{1} \\ 0 & else if ϕ > {ϕ}_{2} \\ 15 \times \frac{ϕ - {ϕ}_{1}}{{ϕ}_{2} - {ϕ}_{1}} & else\end{matrix} \qquad ( 8 )$$

In S602, as the pixel value of the output image identified by the XY coordinate (x, y), the CPU 101 calculates an average value of the pixel values of the fisheye image within a range of ±S horizontally and vertically around the fisheye XY coordinate (x′, y′) as the center and stores the average value. The average of the pixel values is an average of all the pixels within the image region defined by the range of ±S.

In the first embodiment, since copying is performed radially as illustrated in FIGS. 8C and 8D, the user may feel uncomfortable due to the radial image more as the moving radius is greater. According to the present embodiment, with averaging a wider range of the pixel values as the moving radius is greater, it is possible to reduce the uncomfortable feeling described above. Additionally, in the present embodiment, an example in which a wider range of the pixel values are averaged as the moving radius is greater, and a value that is further smoothed is calculated is described. However, the S value may be fixed to calculate the smoothed pixel value, and as described in the third embodiment, blending may be performed such that a smoothing component is increased more as the moving radius is greater. Moreover, in the present embodiment, shading described in the second embodiment may be used together. Furthermore, an average of points sampled to increase the speed may be applied. In a case where sampling is performed, turning-back distortion tends to occur, and the image quality of the smoothed image tends to be deteriorated; however, with use of shading together, the conspicuousness of the turning-back distortion can be reduced.

### (Output Image Example)

### (Use Case vi: Copying, Shading, and LPF Range Variability of End Portion)

In other words, as identified by Expression (8), an image obtained by performing the LPF processing on the image of the image region identified by the S value that is a value increased as the moving radius φ is increased is generated between the moving radius φ₁ and the moving radius φ₂ in the out-of-restriction image region. That is, the CPU 101 generates the output image by copying the image obtained by performing the LPF processing on the image of the image region identified by the S value that is a value increased as the moving radius φ is increased between the moving radius φ₁ and the moving radius φ₂ in the out-of-restriction image region. The CPU 101 outputs the generated output image to be displayed. The output image in this process includes a partial image formed in the restricted image region and a partial image formed in the out-of-restriction image region around the restricted image region. In the restricted image region, the image region in the image with a wide angle of view that is used for the projection conversion is restricted. The restricted image region is an image region identified by the image height smaller than the effective image height. The partial image formed in the out-of-restriction image region is a partial image generated by copying the image obtained by performing the LPF processing on the image of the image region identified by the S value that is a value increased as the moving radius φ is increased between the moving radius φ₁ and the moving radius φ₂. According to the output image including the partial image formed in the out-of-restriction image region as described above, the following actions and effects are obtained. That is, it is possible to generate the pixel value obtained by averaging a wider range of the pixel values as the moving radius φ is greater in the image region created by copying in the out-of-restriction image region. Therefore, it is possible to make roughness in the out-of-restriction image region inconspicuous. Accordingly, it is possible to provide the user with particularly significant immersiveness.

### Fifth Embodiment

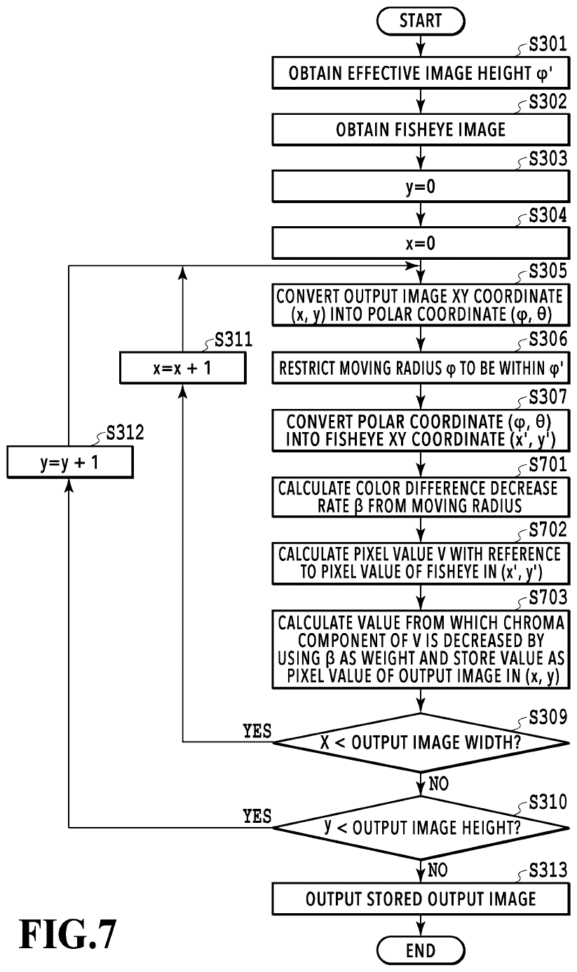

The equidistant cylindrical conversion in which a chroma is reduced more as the moving radius is greater is described with reference to FIG. 7. FIG. 7 is a flowchart describing the projection conversion from the fisheye image into the equidistant cylindrical image with an angle of view of 180° according to the fifth embodiment. In the following, details of the processing executed by the image processing apparatus are described with reference to FIG. 7. The processing illustrated in FIG. 7 is implemented with the CPU 101 executing a program deployed in the memory 103. The processing illustrated in FIG. 7 is executed in a timing of starting the processing of the projection conversion. Note that, a part of or all the functions of the steps in FIG. 7 may be implemented by hardware such as an ASIC or an electronic circuit. A symbol “S” in the description of each processing means that it is a step in the flowchart. Additionally, it is also possible to implement the processing illustrated in FIG. 7 as a configuration of cloud computing that shares one function by multiple resources and performs processing in cooperation via the Internet. Moreover, in a case where there is no change or specific description, the description of the processing is equivalent to the description of FIG. 3 in the first embodiment.

In the processing illustrated in FIG. 7, comparing with the processing illustrated in FIG. 3, processing in S701 and S702 is added, and the processing in S308 is replaced with processing in S703. In S701, the CPU 101 calculates a color difference decrease rate B from the moving radius according to the following expression. In a case where the decrease rate is 1, the chroma is 0; in other words, it is monochrome.

$$β = \{ \begin{matrix}1 & if ϕ < {ϕ}_{1}^{′} \\ 0 & else if ϕ > {ϕ}_{2}^{′} \\ \frac{ϕ - {ϕ}_{1}^{′}}{{ϕ}_{2}^{′} - {ϕ}_{1}^{′}} & else\end{matrix} \qquad ( 9 )$$

Specifically φ′₂ represents the moving radius that allows the chroma to be 0. Additionally, φ′₁ represents the moving radius with which the chroma starts to attenuate. In the present embodiment, a value smaller than the image height with which the false color occurs is set as φ′₂. In S702, the CPU 101 calculates the pixel value v with reference to the pixel value of the fisheye image identified by the fisheye XY coordinate (x′, y′). The pixel value v is a vector expressing RGB. In S703, the CPU 101 calculates a value from which a chroma component of the pixel value v is decreased by using β as a weight and stores the value as the pixel value of the output image identified by the XY coordinate (x, y). The decrease of the chroma component can be implemented by converting RGB into HSV or HSB and multiplying the chroma component by β to decrease the chroma component and then return the value to RGB.

According to the present embodiment, with the chroma being attenuated gradually according to an increase of the moving radius from the inner side of the region in which the false color occurs, it is possible to suppress direct copying of the pixel of the false color even in a case where the effective image height is greater than the image height with which the false color occurs. In the present embodiment, it is also possible to use the shading processing described in the second embodiment and the LPF processing described in the third embodiment and the fourth embodiment together. Additionally, with a combination with the processing of restricting the moving radius to the effective image height threshold described in the first embodiment, it is possible to implement an effect to obtain an image that prevents the user from recognizing the occurrence of the false color.

### (Output Image Example)

### (Use Case vii: Copying, Shading, and Chroma Variability of End Portion)

In other words, as identified by Expression (9), an image in which the chroma is reduced as the moving radius φ is increased is generated between the moving radius φ′₁ with which the chroma starts to attenuate and the moving radius φ′₂ with which the chroma becomes 0 in the out-of-restriction image region. That is, the CPU 101 generates the output image by copying the image in which the chroma is reduced as the moving radius φ is increased between the moving radius φ′₁ with which the chroma starts to attenuate and the moving radius φ′₂ with which the chroma becomes 0 in the out-of-restriction image region. The CPU 101 outputs the generated output image to be displayed. The output image in this process includes a partial image formed in the restricted image region and a partial image formed in the out-of-restriction image region around the restricted image region. In the restricted image region, the image region in the image with a wide angle of view that is used for the projection conversion is restricted. The restricted image region is an image region identified by the image height smaller than the effective image height. The partial image formed in the out-of-restriction image region is a partial image generated by copying the image in which the chroma is reduced as the moving radius φ is increased between the moving radius φ′₁ with which the chroma starts to attenuate and the moving radius φ′₂ with which the chroma becomes 0. According to the output image including the partial image formed in the out-of-restriction image region as described above, the following actions and effects are obtained. That is, it is possible to generate the pixel value in which the chroma is reduced gradually from the center of the image circle toward the outer side along the radiation direction of the moving radius in the image region created by copying in the out-of-restriction image region. Therefore, it is possible to obtain the image that prevents the user from recognizing the occurrence of the false color in the out-of-restriction image region. Accordingly, it is possible to provide the user with particularly significant immersiveness.

Additionally, although it is described that φ′₁ and φ′₂ are fixed values in the present embodiment, a configuration in which the user can designate the value via the UI as described later with reference to FIG. 9B may be applied. FIG. 9B is a diagram illustrating a slider corresponding to each of a chroma-reduction-starting moving radius and a chroma-reduction-ending moving radius in addition to the slider corresponding to each of the threshold of the effective image height, the shading-starting moving radius, and the shading-ending moving radius. The value adjusted by the slider corresponding to each of the chroma-reduction-starting moving radius and the chroma-reduction-ending moving radius corresponds to each of φ′₁ and φ′₂.

Moreover, although a use case where the decrease of the chroma component is calculated in an HSB space or an HSV space is described in the present embodiment, it is not limited thereto. For example, the chroma may be reduced by converting RGB into YUV (brightness (Y), color difference (UV)) and decreasing a UV (U: hue, V: chroma) component. Alternatively, in a case where the calculation is performed in an RGB space according to the following expression, the chroma may be decreased according to β.

$$\begin{matrix}L = 0. 3 \times R + 0.6 \times G + 0.1 \times B \\ ( \begin{matrix}{R}^{′} \\ {G}^{′} \\ {B}^{′}\end{matrix} ) = ( \begin{matrix}( 1 - β ) R + βL \\ ( 1 - β ) G + βL \\ ( 1 - β ) B + βL\end{matrix} )\end{matrix} \qquad ( 10 )$$

In Expression (10), according to an increase in β, a weight of the RGB component is reduced. That is, the values of RGB become more uniform, and a region in which β is 1 becomes monochrome.

### OTHER EMBODIMENTS

As above, the present disclosure is described using various examples and embodiments; however, the intent and the scope of the present disclosure are not limited to the specific descriptions of the present specification. The present disclosure is not limited to the above-described embodiments, and various modifications may be applied. Additionally, the present disclosure may be an appropriate combination of parts of the above-described embodiments.

### (Modification 1)

For example, although an example in which processing is performed by dividing the image with a wide angle of view into two image regions based on the effective image height is described, it is not particularly limited thereto. For example, a state in which the image with a wide angle of view is embedded in another image may be applied. Specifically, a case of editing a single image in which a periphery of the image with a wide angle of view is surrounded by the other image is a state in which the image with a wide angle of view is embedded in the other image. Even in the above-described state, with use of the effective image height, it is also possible to exclude the image region including the image corresponding to the image height exceeding the effective image height, which is in the image region including the image with a wide angle of view, from the application of the processing of the projection conversion. Note that, the other image is an image of an actual video or a CG image, for example. That is, specifically, a system that sets the image of the actual video or the CG image as a background image and displays an image in which the image with a wide angle of view of the present disclosure is incorporated in a part of the background image on a display unit such as the HMD may be applied.

### (Modification 2)

Additionally, although an example of the projection conversion from the image expressed by the two-dimensional coordinate system as the input target into the image expressed by the two-dimensional coordinate system as the output target by using the image expressed by another two-dimensional coordinate system is described, it is not particularly limited thereto. For example, the projection conversion from the image expressed by the two-dimensional coordinate system as the input target into the image expressed by the two-dimensional coordinate system as the output target may be performed by using an image expressed by an arbitrary three-dimensional coordinate system. Alternatively, the projection conversion from the image expressed by the two-dimensional coordinate system as the input target into the image expressed by the two-dimensional coordinate system as the output target may be performed by using an image expressed by the same coordinate system. In this case, with use of the image expressed by the same coordinate system, it is possible to achieve geometric conversion of the image as the projection conversion, such as enlargement, contraction, rotation, parallel displacement, inversion, and skewing of the image. The above-described geometric conversion makes it possible to perform correction to remove distortion of the image. For example, in a case where the moving radius is distorted, it is also possible to remove the distortion of the moving radius by converting the fisheye image into the fisheye image by the geometric conversion in the same coordinate system and comparing the two fisheye images.

### (Modification 3)

Moreover, although an example of the UI to designate the equidistant cylindrical conversion parameter is described with reference to each of FIGS. 9A and 9B, a configuration that allows the user to select either of FIGS. 9A and 9B may be applied. For example, a radio button may be additionally displayed on the UI of each of FIGS. 9A and 9B. With an input form such as the radio button to select specific one of multiple options being additionally displayed on the UI, the user can select the UI as needed.

### (Modification 4)

Furthermore, although the use cases i to vii are described as an applied image example, a configuration of the UI that makes it possible to select at least one of the output images of the use cases i to vii as needed may be applied.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to improve the immersiveness of a user viewing an image.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-221925, filed Dec. 18, 2024 which is hereby incorporated by reference herein in its entirety.

What is claimed is:

1. An image processing apparatus, comprising:
an image obtainment unit configured to obtain an image with a wide angle of view, the wide angle of view being an angle of view exceeding a predetermined value;
a restriction unit configured to restrict an image region to a restricted image region, the image region used for projection conversion in the image with the wide angle of view; and
a conversion unit configured to perform projection conversion of a coordinate system of an image in the restricted image region into a coordinate system of an image of an output target, in the image with the wide angle of view.

2. The image processing apparatus according to claim 1, wherein
the conversion unit does not perform projection conversion of a coordinate system of an image in an out-of-restriction image region, which is outside the restricted image region, into the coordinate system of the image of the output target.

3. The image processing apparatus according to claim 2, further comprising:
an upper limit obtainment unit configured to obtain an effective image height being an upper limit value of an image height indicating an imaging height from a center of an optical axis of an image capturing optical system used to capture the image with the wide angle of view, as a threshold making it possible to identify the restricted image region and the out-of-restriction image region.

4. The image processing apparatus according to claim 3, wherein
in the image region including the image with the wide angle of view, the restriction unit restricts to the restricted region an image region identified by an image height being smaller than the effective image height and the restriction unit restricts to the out-of-restriction image region an image region identified by an image height equal to or greater than the effective image height.

5. The image processing apparatus according to claim 3, wherein
the out-of-restriction image region may include an image region in which false color occurs.

6. The image processing apparatus according to claim 5, wherein
the effective image height is set within a range in which a pixel of a specific color among a plurality of colors forming the image with the wide angle of view, the pixel of the specific color does not exceed a preset number of pixels and the pixel of specific color does not extend into an image area including a pixel of a color being different from the specific color.

7. The image processing apparatus according to claim 6, wherein
the image obtainment unit obtains a fisheye image as the image with the wide angle of view.

8. The image processing apparatus according to claim 7, wherein
as the coordinate system of the image of the output target, the conversion unit converts a coordinate system of the fisheye image into an orthogonal coordinate system of an equidistant cylindrical image.

9. The image processing apparatus according to claim 8, wherein
the image height is determined by a distance from a start point that is the center of image capturing, which is an intersection point of the center of the optical axis and an image plane of the image capturing optical system, in a radiation direction of a moving radius indicating an element of a polar coordinate in a case of representing each pixel position in the image plane by the polar coordinate, and
in a case where the image with the wide angle of view is expressed by a coordinate system of the polar coordinate, the restriction unit restricts the moving radius to be equal to or smaller than the effective image height.

10. The image processing apparatus according to claim 9, further comprising:
a preprocessing conversion unit configured to convert a coordinate system of the image with the wide angle of view into the coordinate system of the polar coordinate before restricting the moving radius to be smaller than the effective image height.

11. The image processing apparatus according to claim 10, wherein
the conversion unit sets an orthogonal coordinate system as a coordinate system of the output target.

12. The image processing apparatus according to claim 11, wherein
the conversion unit converts the coordinate system of the image with the wide angle of view into the orthogonal coordinate system from the coordinate system of the polar coordinate.

13. The image processing apparatus according to claim 12, wherein
an output image expressed by the coordinate system of the output target is the equidistant cylindrical image.

14. The image processing apparatus according to claim 9, wherein
in a case where the moving radius is equal to or greater than the effective image height,
according to a condition of
$${ϕ}_{new} = \{ \begin{matrix}ϕ & if ϕ < {ϕ}^{′} \\ {ϕ}^{′} & else\end{matrix}$$
where
the moving radius is φ, the effective image height is φ′, and the moving radius restricted to be equal to or smaller than the effective image height is φ_{NEW},
the restriction unit restricts an image region to be used, which is in an image region including the image with the wide angle of view, to the restricted image region.

15. The image processing apparatus according to claim 9, wherein
in a case where the moving radius is equal to or greater than the effective image height,
according to a condition of
$${ϕ}_{new} = \{ \begin{matrix}ϕ & if ϕ < {ϕ}^{′} \\ {ϕ}^{′} - ( ϕ - {ϕ}^{′} ) & else\end{matrix}$$
where
the moving radius is φ, the effective image height is φ′, and the moving radius restricted to be equal to or smaller than the effective image height is φ_{NEW},
the restriction unit restricts an image region to be used, which is in an image region including the image with the wide angle of view, to the restricted image region.

16. The image processing apparatus according to claim 9, further comprising:
a smoothing unit configured to increase a degree of smoothing of an image in the out-of-restriction image region as the moving radius is increased.

17. The image processing apparatus according to claim 16, wherein
as the moving radius is increased, the smoothing unit increases the degree of smoothing of the image in the out-of-restriction image region and increases an image region on which the smoothing is performed.

18. The image processing apparatus according to claim 9, further comprising:
a decreasing unit configured to decrease a chroma of an image in the out-of-restriction image region as the moving radius is increased.

19. An image processing method, comprising:
obtaining an image with a wide angle of view, the wide angle of view being an angle of view being an angle of view exceeding a predetermined value;
restricting an image region to a restricted image region, the image region used for projection conversion in the image with the wide angle of view; and
performing projection conversion of a coordinate system of an image in the restricted image region into a coordinate system of an image of an output target, in the image with the wide angle of view.

20. A computer-readable storage medium storing a program causing a computer to execute:
obtaining an image with a wide angle of view, the wide angle of view being an angle of view being an angle of view exceeding a predetermined value;
restricting an image region to a restricted image region, the image region used for projection conversion in the image with the wide angle of view; and
performing projection conversion of a coordinate system of an image in the restricted image region into a coordinate system of an image of an output target, in the image with the wide angle of view.
